(19) United States
(12) Patent Application Publication
(10) Pub. No.: US 2010/0098965 A1
(43) Pub. Date: Apr. 22, 2010

(54) METHOD FOR FORMING A CONCENTRIC MULTIPLE LOOPED STRUCTURE

(76) Inventors: Thomas Mask, Charlotte, NC (US); Mark Evans, Mooresville, NC (US)

Correspondence Address: SCHWARTZ LAW FIRM P.C.;SCHWARTZ JEFFERY J., SOUTH PARK TOWERS, 6100 FAIRVIEW ROAD SUITE 1135, CHARLOTTE, NC, 28210, US

(21) Appl. No.: 12/449,191

(22) PCT Filed: Jan. 24, 2008
(86) PCT No.: PCT/US08/00892

§ 371 Date: Dec. 9, 2009

Related U.S. Application Data
(60) Provisional application No. 60/897,142, filed on Jan. 24, 2007.

(51) Int. Cl. B23B 1/00; B32B 15/01; B32B 1/00

(52) U.S. Cl. 428/592; 82/1.11; 428/174

(57) ABSTRACT

A method for forming a concentric multiple looped structure from an elongated rigid workpiece includes rotating one of the workpiece and a cutting tool relative to the other of the workpiece and cutting tool. The cutting tool has a shear edge operatively mounted to engage an end face of the workpiece. The shear edge of the cutting tool is urged against the end face of the workpiece to cut the workpiece during rotation of one of the workpiece and cutting tool relative to the other of the workpiece and cutting tool. The workpiece is cut into a continuous series of connected loops forming a concentric multiple looped structure.

### TECHNICAL FIELD AND BACKGROUND

The present disclosure relates broadly to the fields of electronics and magnetics, and more specifically, to a method employed to produce an array of concentric multiple looped structures, such as medical imaging magnetics, radio transmission coils, radar systems, power generation systems, inductors, power transformers, antennas, voice coils, motor windings, induction heating elements, springs, and others. In one exemplary implementation, the present method is applicable for producing helical products to specifications that may be practically unattainable using conventional edge-winding techniques.

The prior art is characterized by inefficiencies in the techniques used to produce and wind magnet wire into coils for use as magnetic or electronic devices. These methods typically draw the wire through multiple dies to reduce the diameter of the conductor and shape it. The wire is then insulated prior to wounding around a form to produce a coil. Such methods often increase stress on the wire and insulation during forming and winding, as these elements must be bent around the form and tensioned to prevent slippage. Such methods also produce a relatively low packing efficiency in the insulated coil. Another prior art method takes round insulated wire and flattens it between rollers to produce a flat wire which is then wound through slotted rollers around a form to produce an edge-wound insulated coil. While edge-wound insulated coils may have an improved packing efficiency, this advantage is often achieved at the expense of deforming the wire and insulation during the flattening and winding process.

Additionally, conventional winding techniques generally impose an adverse effect on the coiled conductor—often referred to as “keystoning.” Keystoning appears readily as a trapezoidal deformation in the profile of the conductor caused by the process of bending the flat wire around a coil form. Keystoning is characterized by the narrowing of the conductor thickness around the outer edge of the coiled conductor, and the thinning of the insulation in the same area. This distortion can be accurately measured as a deviation in conductor thickness from the inner coil radius (ID) to the outer coil radius (OD). Keystoning and other winding distortion can restrict the ability to produce a flat wire edge-wound coil having a relatively large OD to ID ratio (e.g., greater than a 4:1), as the outer edge of the resulting conductor may be one-half of the original wire thickness, or less. This level of deformation is generally unacceptable in practice.

In addition to keystoning and other conductor deformation, coil forming/winding techniques which rely on bending a conductor wire around or through a form have other disadvantages, including increased part fatigue, increased failure rates among components, and a relatively high cost of manufacture. While edge-wound helical coils may have performance advantages over their predecessors, particularly as application power levels and frequencies increase for electronic devices, resolving the problems and disadvantages in manufacturing such coils using prior art techniques, even with modest conductor sizes, may be prohibitively costly.

The present method addresses many of the drawbacks and limitations of conventional coil-forming techniques discussed above. In one exemplary implementation, the present method may be employed to form any multiple looped structure (e.g., helical coil) of metal or other material without bending or otherwise deforming the material. The present method may produce a flat conductor, profiled conductor, and multi-conductor helical coils without the wire and insulation deformation and material stress inherent in conventional prior art techniques, and without the physical limitations brought on by associated conductor and insulation deformation. Because helical coils can be produced without the conventional winding step, as this is no longer necessary, the present method produces no keystoning, minimal stress to the conductor, and allows the helical coil to be formed to a high degree of precision. The coil may be insulated as a component after application of the present method, thereby eliminating potential stress on the insulation during formation of the coil. Additionally, the present method may be employed to form helical coils of a wide variety of sizes and shapes with precise control of conductor widths, thicknesses, and profiles without costly tooling changes, as well as producing coil and conductor sizes, shapes, and pitches that were previously not feasible.

### SUMMARY OF EXEMPLARY EMBODIMENTS

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may. Additionally, the terms “embodiment” and “implementation” are used interchangeably herein.

In one exemplary embodiment, the invention may comprise a method for forming a concentric multiple looped structure from an elongated rigid workpiece. The exemplary method includes rotating one of the workpiece and a cutting tool relative to the other of the workpiece and cutting tool. The cutting tool has a shear edge operatively mounted to engage an end face of the workpiece. The shear edge of the cutting tool is urged against the end face of the workpiece to cut the workpiece during rotation of one of the workpiece and cutting tool relative to the other of the workpiece and cutting tool. The workpiece is cut into a continuous series of connected loops forming a concentric multiple looped structure. Either one of the cutting tool and workpiece may be advanced towards the other by means of a synchronous tool positioning system which determines the pitch of the multiple looped structure. The multiple looped structure (e.g., conductor coil) may have a dimensional profile determined by the profile of the workpiece, and a conductor profile determined by the profile of the cutting tool.

The term “loop” is defined broadly herein to mean any curved, bent, and/or angled structure which extends over on itself to define a center opening therebetween.

According to another exemplary embodiment, the method may include mounting the workpiece in a chuck of a machine tool.

According to another exemplary embodiment, the method may include rotating the chuck and workpiece relative to the cutting tool.

According to another exemplary embodiment, the method may include moving the cutting tool axially towards the workpiece during cutting.

According to another exemplary embodiment, the method may include leveling the end face of the workpiece prior to forming the concentric multiple looped structure.

According to another exemplary embodiment, the method may include urging the shear edge of the cutting tool against the end face of the workpiece at a predetermined fixed location relative to a center point of the end face.

According to another exemplary embodiment, the method includes urging the shear edge of the cutting tool against the end face of the workpiece at a substantially constant and uniform pressure.

According to another exemplary embodiment, the method includes cutting the workpiece such that each connected loop has a relatively large width and is relatively thin.

According to another exemplary embodiment, the method includes cutting the workpiece such that each connected loop is substantially flat across its width.

In another exemplary embodiment, the invention may include a method for forming a concentric multiple looped structure from an elongated tubular metal workpiece. The method may include rotating one of the workpiece and a cutting tool relative to the other of the workpiece and cutting tool. The cutting tool has a shear edge operatively mounted to engage an end face of the workpiece. The shear edge is urged against the end face of the workpiece to cut the workpiece during rotation of one of the workpiece and cutting tool relative to the other of the workpiece and cutting tool. The workpiece is cut into a continuous series of connected metal loops forming a concentric multiple looped structure.

According to another exemplary embodiment, the method includes cutting the workpiece such that the concentric multiple looped structure comprises a helical coil.

According to another exemplary embodiment, the method includes cutting the workpiece such that each loop of the helical coil has a relatively large width and is relatively thin.

According to another exemplary embodiment, the method includes cutting the workpiece such that the helical coil has a generally uniform outside diameter along the series of connected loops, and a generally uniform inside diameter along the series of connected loops.

According to another exemplary embodiment, the method includes cutting the workpiece such that the helical coil has an outside diameter to inside diameter ratio of greater than 10:1.

According to another exemplary embodiment, the method includes cutting the workpiece such the helical coil has an outside diameter to inside diameter ratio of greater than 50:1.

According to another exemplary embodiment, the method includes cutting the workpiece such that the helical coil has an outside diameter to inside diameter ratio of greater than 100:1.

In yet another exemplary embodiment, the invention may comprise a method for forming a concentric multiple looped structure from an elongated rigid workpiece having a hollow core and an irregular shaped cross-section. The method includes rotating one of the workpiece and cutting tool relative to the other of the workpiece and cutting tool. The cutting tool has a shear edge operatively mounted to engage an irregular shaped end face of the workpiece. The shear edge of the cutting tool is urged against the face of the workpiece to cut the workpiece during rotation of one of the workpiece and cutting tool relative to the other of the workpiece and cutting tool. The workpiece is cut into a continuous series of connected irregular shaped loops forming a concentric multiple looped structure.

The term “irregular shaped” is defined broadly herein to mean any non-circular shape including (but not limited to) squares, ovals, hexagons, octagons, triangles, and virtually any random curved and/or straight-edged form.

The exemplary method may produce multiple looped structures having any number of nested layers. For example, several concentric conductive tubes separated by electrically insulating layers may be shear formed according to the present method to produce multiple winding layers in a single operation. These layers may then be connected together in any order or polarity that suits the application, or may be addressed as individual windings of a concentric nature.

The exemplary method may also produce multiple looped structures having little or no internal diameter. Such structures may act as helically finned conductors because the small internal diameter (or lack of an internal diameter) approximates a straight line, and has the electrical effect of appearing as a straight conductor that if properly insulated has the novel effect of increased inductance of the conductor.

The exemplary method may also produce multiple looped structures having non-rectangular profiles, such as (e.g.) curved, waved, stepped, diagonal and angled. Nearly all parallel surface profiles are possible.

The exemplary method may also produce multiple looped structures having transitional geometry, i.e. tapered or profiled inner or outer surfaces, special shapes, and even irregular forms. Because the inner and outer surface features of the multiple looped structure correspond to those of the workpiece (which may be shaped independent of the present method), and because the present method does not remove any profile material or otherwise distort the shape of the profile, even the most elaborate shapes may be produced.

The exemplary method may also be scaled up or down in size, while maintaining dimensional stability of both the multiple looped structure and the conductor for maximum efficiency of the finished product.

The exemplary method may also provide an opportunity to anneal the multiple looped structure in its formed state prior to being insulated. This may improve the electrical and thermal conductivity of the coil, and may also mitigate the effects of work hardening, without potentially damaging the insulation as a result of the heat necessary to anneal the coil.

The exemplary method may enable the construction of multiple looped structures from a wide variety of materials without changes in tooling or the production method. Examples of such materials include (but are not limited to) copper, aluminum, silver, gold, or any other machinable metal, plastic, organic, synthetic or composite.

The exemplary method may also enable the construction of multiple looped structures (e.g., coils) with previously unavailable height to width ratios, coil inside to outside diameter ratios, and coil pitches. Indeed, the exemplary method may be employed to create multiple looped structures of virtually any desired thickness, width, thickness to width ratio, inside diameter, outside diameter, ID to OD ratio, length, and pitch.

### BRIEF DESCRIPTION OF THE DRAWINGS

The description of exemplary embodiments proceeds in conjunction with the following drawings, in which:

FIG. 1 is a perspective view of a machine tool applicable for use in the present method for forming concentric multiple looped structures;

FIG. 2 is a side view of the machine tool;

FIG. 3 is top view of the machine tool;

FIG. 4 is an end view of the machine tool;

FIGS. 5 and 6 are views of one multiple looped structure formed according to an exemplary implementation of present method; and

FIGS. 7 and 8 are views of another multiple looped structure formed according to an exemplary implementation of the present method.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at lease one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended to infer a preference for one or more exemplary embodiments described herein, and are not intended as an affirmation that the invention has been previously reduced to practice or that any testing has been performed. Likewise, unless stated otherwise, use of verbs in the past tense (present perfect or preterite) is not intended to indicate or imply that the invention has been previously reduced to practice or that any testing has been performed.

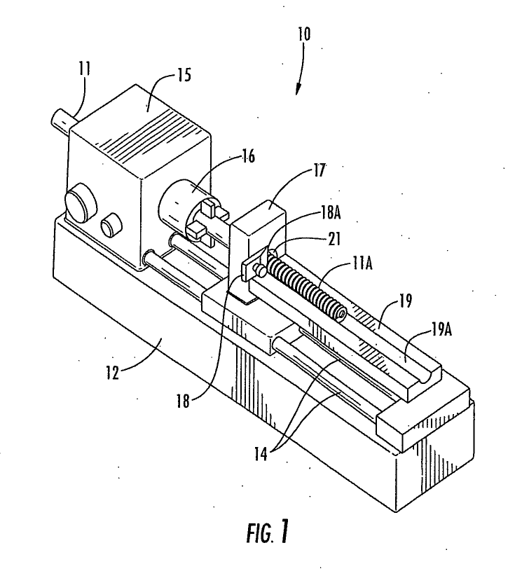

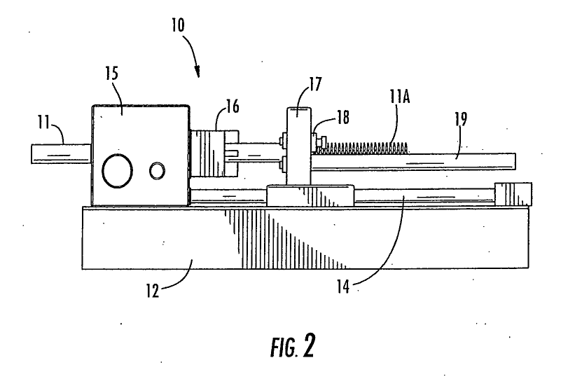

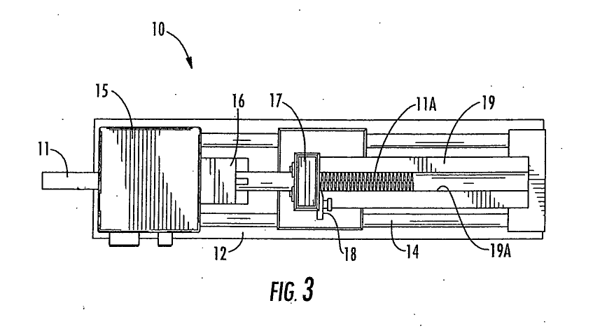

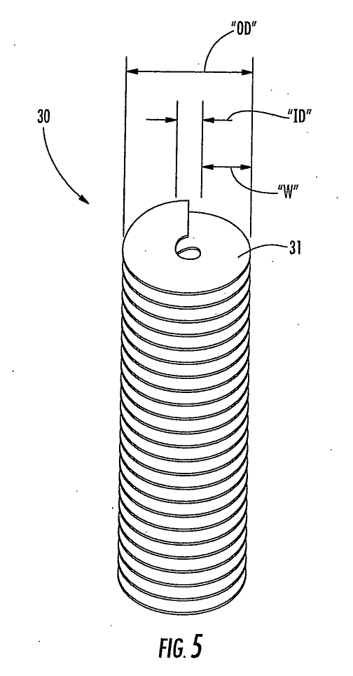

Referring now specifically to the drawings, a machine tool for manufacturing concentric multiple looped structures according to one exemplary embodiment of the present invention is illustrated in FIGS. 1-4, and shown generally at reference numeral 10. Examples of multiple looped structures formed by the present method are shown in FIGS. 5-8, discussed below.

Referring to FIGS. 1-4, the machine tool 10 may comprise any device or apparatus designed to remove material from an elongated workpiece 11, through the action of a cutting device. In the exemplary embodiment, described below, the present method utilizes a metal lathe comprising a supporting iron bed 12 with longitudinal ways 14, a headstock 15 fixedly mounted on the bed 12 and comprising a rotatable chuck 16 (and gearbox-driven spindle, not shown), a movable tool carriage 17 carried on the ways 14 of the bed 12, an adjustable cutting tool 18 secured to the carriage 17, and a cantilevered deck 19 for supporting the cut workpiece 11A. The lathe 10 may further incorporate conventional structure, attachments, and features not shown or described herein, but well known and understood to those of ordinary skill in the machine tool industry.

The rotatable chuck 16 comprises any structural means for holding the workpiece at the headstock 15 of the lathe 10. For example, the lathe 10 may incorporate any conventional collet or multi-jaw chuck, such as the self-centering four-jaw chuck shown. Alternatively, for ferromagnetic workpieces, the lathe 10 may utilize a magnetic chuck. As such, the term “chuck” is used broadly herein to cover any conventional multi-jaw chuck, collet, sleeve, clamp, and other holding devices.

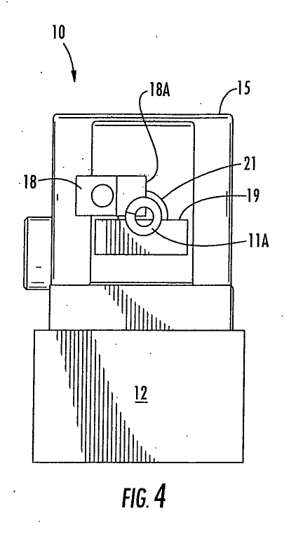

The carriage 17 has a saddle that mates with and slides along the ways 14 of the bed 12, an apron that controls feed mechanisms for driving the carriage, a cross slide that controls transverse adjustment of the cutting tool 18 (towards and away from the operator), and a tool compound that adjusts to permit angular movement of the cutting tool 18. The carriage 17 may travel by means of a drive shaft (or “feedscrew”) and a series of gears located in the carriage apron. A generally ring-shaped rest may be bolted to a head-side of the carriage 17 at opening 21, and may serve to bear against the workpiece 11 opposite the cutting tool 18 to reduce deflection during cutting. As best shown in FIGS. 1 and 4, the adjustable cutting tool 18 is arranged to project radially at the opening 21 on a tail-side of the carriage 17. The cutting tool 18 may comprise any shaped blade defining a shear edge 18A applicable for engaging and cutting the workpiece 11. As the rotating workpiece 11 is cut, the resulting multiple loop structure 11A is fed onto the cantilevered deck 19 extending from the carriage 17 towards the tail end of the lathe 10. The deck 19 may have a longitudinally formed arcuate channel 19A designed to locate and safely hold the structure 11A.

Forming the Concentric Multiple Loop Structure

The exemplary method is initiated by loading the workpiece 11 into the lathe 10 through the headstock 15 and chuck 16, and then locking the chuck 16 onto a proximal end of the workpiece 11. In the present example, the workpiece 11 comprises an elongated hollow cylindrical metal tube having an inside diameter and an outside diameter, and an end face formed generally perpendicular to its longitudinal axis. The end face may be leveled in separate facing-off process.

A distal end of the workpiece 11 extends outwardly from the chuck 16 and enters the carriage opening 21 through the ring-shaped rest. The end face of the workpiece 11 is substantially aligned with the shear edge 18A of the adjustable cutting tool 18 to a predetermined depth of cut. The lathe 10 is then powered up to rotate the chuck 16 and workpiece 11 at a predetermined cutting speed. Typical cutting speeds may range from about 3 to 30 turns per second, or more. As the workpiece 11 rotates, the cutting tool 18 is moved (e.g., automatically) by the cross slide across the end face of the workpiece 11, and is advanced by the carriage 17 towards the headstock 15 at a predetermined feed rate. Typical feed rates may range from 0.5 mil-100 mil per turn. The “cutting speed” is defined herein as the speed at which the workpiece 11 moves with respect to the cutting tool 18, while the “feed rate” is the axial distance the cutting tool 18 advances during one revolution of the workpiece 11.

When initiating the cut, the shear edge 18A of the cutting tool 18 is fed across the end face of the workpiece 11 to predetermined fixed location relative to a center point of the end face, and the cutting tool 18 held at a fixed orientation; e.g., substantially perpendicular to the direction of rotation. The cutting tool 18 may also be angled into the end face of the workpiece 11 by a few degrees, such that only the shear edge 18A of the tool 18 engages the workpiece 11. This may result in less heat and friction on the workpiece 11 and cutting tool 18. As the cutting tool 18 is advanced into the rotating workpiece 11, the shear edge 18A cuts the workpiece end face into a continuous series of connected flat loops forming a concentric multiple looped structure 11A. Using a tubular workpiece 11, the resulting structure 11A comprises a helical coil having an inside and outside diameter corresponding to that of the pre-cut workpiece 11, and having a pitch proportionate to an operator-selected ratio of cutting speed to feed rate. The workpiece 11 may be cut such that the connected loops are substantially identical and concentric, and such that each loop has a substantially uniform and consistent thickness (or thinness) from an outside diameter of the loop to an inside diameter of the loop. The workpiece 11 may also be cut such that each connected loop of the helical coil has a relatively large width and is relatively thin (i.e., the width dimension of the loop is greater than its thinness/thickness). Alternatively, the thinness/thickness of the loop may be equal to or greater than the width dimension. Additionally, the workpiece 11 may define a relative small throughbore or center hole, such that after cutting the resulting helical coil has an outside diameter to inside diameter ratio of greater than 10:1, or greater than 50:1, or greater than 100:1, or more. The present method can also be used to create concentric multiple loop structures from elongated solid workpieces without a center opening.

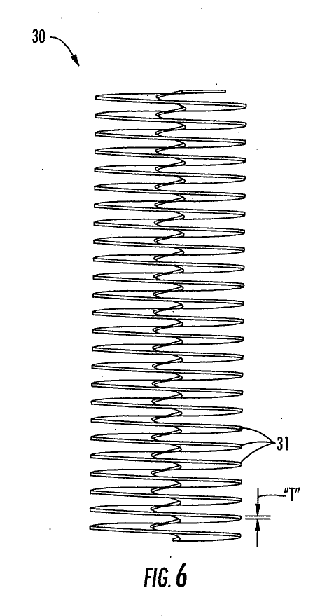

FIGS. 5-8 illustrate embodiments of concentric multiple looped structures 30 and 40 formed according to exemplary implementations of the present method described above. The structure 30 shown in FIGS. 5 and 6 comprises a continuous series of spaced-apart, flat, connected loops 31 forming a helical coil having a relative small inside diameter “ID” and a relatively large outside diameter “OD”. The structure 30 has a generally uniform outside diameter “OD” along the series of connected loops 31, and a generally uniform inside diameter “ID” along the series of connected loops 31. Additionally, each connected loop 31 has a substantially uniform and consistent thickness (or thinness) “T” from an outside diameter “OD” of the loop 31 to the inside diameter “ID” of the loop 31, and a relatively large width “W”.

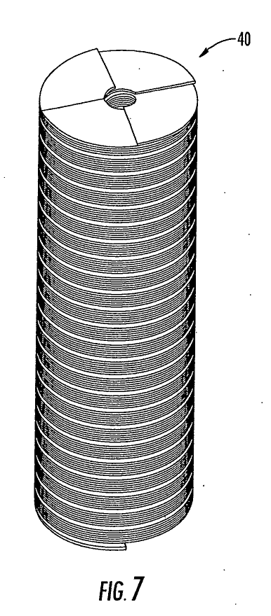

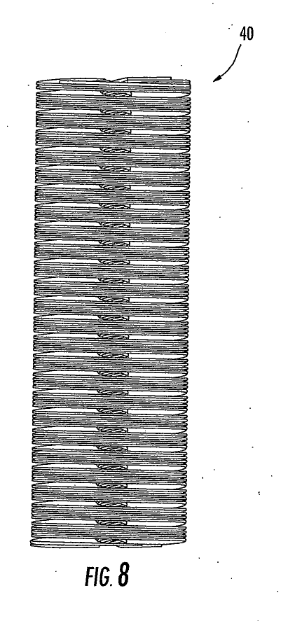

The structure 40 shown in FIGS. 7 and 8 is a quadfiler coil comprising four interleaved helical coils; each coil defining a continuous series of spaced-apart, flat, connected loops with each loop having a relative small inside diameter and a relatively large outside diameter. The structure 40 may be formed using one or more cutting tools having (collectively) four shear edges fixedly arranged at 90 degrees to one another, such that the rotating workpiece may be cut in a single pass to simultaneously form each coil of the multi-coil structure 40 in the manner described above. Other multiple-coil structures may be formed in an identical manner using cutting tools having a corresponding number of spaced shear edges.

In view of the present disclosure, it should be obvious to those skilled in the art that there are many embodiments and implementations not set forth herein that could be realized without deviating from the spirit or intended scope of the invention, among them are non-coils or helical bodies that are not electrically conductive or are not intended for that purpose. These helical bodies may find use as toys, structural members, springs, learning aides, models, guides, insulators, spacers, or other items not specifically noted herein.

Exemplary embodiments of the present invention are described above. No element, act, or instruction used in this description should be construed as important, necessary, critical, or essential to the invention unless explicitly described as such. Although only a view of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

I claim:

1. A method for forming a concentric multiple looped structure from an elongated rigid workpiece, the method comprising:
rotating one of the workpiece and a cutting tool relative to the other of the workpiece and cutting tool, the cutting tool having a shear edge operatively mounted to engage an end face of the workpiece;
urging the shear edge of the cutting tool against the end face of the workpiece to cut the workpiece during rotation of one of the workpiece and cutting tool relative to the other of the workpiece and cutting tool; and
cutting the workpiece into a continuous series of connected loops forming a concentric multiple looped structure.

2. A method according to claim 1, and comprising mounting the workpiece in a chuck of a machine tool.

3. A method according to claim 2, and comprising rotating the chuck and workpiece relative to the cutting tool.

4. A method according to claim 3, and comprising moving the cutting tool axially towards the workpiece during cutting.

5. A method according to claim 1, and comprising leveling the end face of the workpiece prior to forming the concentric multiple looped structure.

6. A method according to claim 1, and comprising urging the shear edge of the cutting tool against the end face of the workpiece at a predetermined fixed location relative to a center point of the end face.

7. A method according to claim 1, and comprising urging the shear edge of the cutting tool against the end face of the workpiece at a substantially constant and uniform pressure.

8. A method according to claim 1, and comprising cutting the workpiece such that each connected loop has a relatively large width and is relatively thin.

9. A method according to claim 8, and comprising cutting the workpiece such that each connected loop is substantially flat across its width.

10. A concentric multiple looped structure according to the method of claim 1.

11. A method for forming a concentric multiple looped structure from an elongated tubular metal workpiece, the method comprising:
rotating one of the workpiece and a cutting tool relative to the other of the workpiece and cutting tool, the cutting tool having a shear edge operatively mounted to engage an end face of the workpiece;
urging the shear edge of the cutting tool against the end face of the workpiece to cut the workpiece during rotation of one of the workpiece and cutting tool relative to the other of the workpiece and cutting tool; and
cutting the workpiece into a continuous series of connected metal loops forming a concentric multiple looped structure.

12. A method according to claim 11, and comprising cutting the workpiece such that the concentric multiple looped structure comprises a helical coil.

13. A method according to claim 12, and comprising cutting the workpiece such that each loop of the helical coil has a relatively large width and is relatively thin.

14. A method according to claim 13, and comprising cutting the workpiece such that the helical coil has a generally uniform outside diameter along the series of connected loops, and a generally uniform inside diameter along the series of connected loops.

15. A method according to claim 14, and comprising cutting with workpiece such that the helical coil has an outside diameter to inside diameter ratio of greater than 10:1.

16. A method according to claim 14, and comprising cutting with workpiece such the helical coil has an outside diameter to inside diameter ratio of greater than 50:1.

17. A method according to claim 14, and comprising cutting with workpiece such that the helical coil has an outside diameter to inside diameter ratio of greater than 100:1.

18. A method according to claim 11, and comprising cutting the workpiece such that each loop has a substantially uniform and consistent thickness from an outside diameter of the loop to an inside diameter of the loop.

19. A concentric multiple looped structure according to the method of claim 11.

20. A method for forming a concentric multiple looped structure from an elongated rigid workpiece having a hollow core and an irregular shaped cross-section, the method comprising:
rotating one of the workpiece and cutting tool relative to the other of the workpiece and cutting tool, the cutting tool having a shear edge operatively mounted to engage an irregular shaped end face of the workpiece;
urging the shear edge of the cutting tool against the face of the workpiece to cut the workpiece during rotation of one of the workpiece and cutting tool relative to the other of the workpiece and cutting tool; and
cutting the workpiece into a continuous series of connected irregular shaped loops forming a concentric multiple looped structure.
